(19) United States
(12) Patent Application Publication
(10) Pub. No.: US 2016/0288140 A1
(43) Pub. Date: Oct. 6, 2016

(54) HYBRID CENTRIFUGAL FILTER

(71) Applicant: SHIN HEUNG PRECISION CO., LTD., Ulju-gun, Ulsan (KR)

(72) Inventors: Yong-Keun KIM, Ulsan (KR); Kyo-Hye YE, Ulsan (KR)

(73) Assignee: SHIN HEUNG PRECISION CO., LTD, Ulju-gun, Ulsan (KR)

(21) Appl. No.: 15/035,393

(22) PCT Filed: May 9, 2014
(86) PCT No.: PCT/KR2014/004122

§ 371 Date: May 9, 2016

(30) Foreign Application Priority Data
Apr. 18, 2014 (KR) 10-2014-0046580

(51) Int. Cl. B04B 7/16; B01D 35/00; B04B 3/00

(52) U.S. Cl. CPC B04B 7/16; B04B 3/00; B01D 35/005; F01M 1/10

(57) ABSTRACT

The present invention provides a hybrid centrifugal filter including: a casing having a fluid inlet and a fluid outlet; a shaft vertically disposed in the casing and guiding fluid, which flows inside through the fluid inlet, into the casing; a stand tube being rotatable about the shaft and injecting fluid flowing in the casing through the shaft; a rotor disposed in the casing to form a space for filtering the fluid injected from the stand tube by rotating with the stand tube, and having nozzles injecting the filtered fluid into the casing; and a filtering unit elongated in a longitudinal direction of the shaft, disposed in the rotor to divide an inside of the rotor into an upper space and a lower space, and having a plurality of fluid holes for guiding the fluid injected in the upper space from the stand tube into the lower space.

### TECHNICAL FIELD

The present invention relates to a centrifugal filter used for filtering impurities out of fluid and, more particularly, to a hybrid centrifugal filter that can more efficiently remove impurities including fine particles of 10 μm or less by increasing the surface area that comes into contact with impurities by using a filtering member further provided in a rotor.

### BACKGROUND ART

In general, a centrifugal filter, which is a device performing the functions of separation, purification, and concentration of liquids that are different in components and specific gravities by using a centrifugal force, is used also for filtering liquid-state impurities.

FIG. 1 is a sectional view showing a structure of the centrifugal filter according to a conventional art.

The centrifugal filter shown in FIG. 1 is used in filtering impurities out of fluid for engines.

The centrifugal filter includes: a shaft 10 provided with a flow path 11 therein through which fluid is introduced; a rotor configured to rotate around the shaft 10; a stand tube 30 configured to rotate around the shaft 10 with the rotor 20, the stand tube jetting the fluid introduced through the shaft into the rotor; and a casing 40 having an fluid inlet 41 and an fluid outlet 42 and housing the rotor 20 therein.

The centrifugal filter receives and filters some of fluid that is supplied to an engine or mechanical devices by a pump (not shown).

In detail, the rotor 20 rotates at high speed by using a reaction force produced during fluid-jetting through a nozzle 21 provided in the rotor, impurities in fluid jetted from the stand tube 30 are separated from the fluid by a difference is specific gravity and centrifugal force, and the separated impurities stick to a paper (not shown) on the inner side of the rotor 20, thereby filtering impurities.

However, the centrifugal filter is not efficient to filter 10 μm or less fine particles. That is, the smaller the size of the impurity particles, the less the particles are influenced by centrifugal force, and thus impurity particles having small sizes cannot reach the paper on the inner side of the rotor 20 to drop with fluid. Accordingly, the centrifugal filter of the related art is considered not to filter fine particles of 10 μm or less.

As a result, though the centrifugal filter of the related art has the advantage of being able to filter a large amount of impurities, it has the defect of not being able to efficiently filter fine particles of 10 μm or less.

On the other hand, common filters having a structure that passes only particles having a predetermined size or less can efficiently remove even impurities having a size of 10 μm or less, depending on the structure, but they cannot cope with a large amount of impurities. Further, as time passes, filtered impurities are accumulated on the surface and increase resistance against flow of fluid, so the filters should be frequently replaced.

### DOCUMENTS OF RELATED ART

(Patent Document 1) Korean Patent No. 1003524 (published on 30 Dec. 2010)

### DISCLOSURE

### Technical Problem

The present invention has been made in an effort to solve the problems and an object of the present invention is to provide a hybrid centrifugal filter that can efficiently remove impurities by having the advantages of both of a centrifugal filter and a common filter by additionally providing a specific filtering unit in a rotor.

### Technical Solution

In order to achieve the object and remove defects of the related art, the present invention provides a hybrid centrifugal filter that includes: a casing having a fluid inlet and a fluid outlet; a shaft vertically disposed in the casing and guiding fluid, which flows inside through the fluid inlet, into the casing; a stand tube being rotatable about the shaft and injecting fluid flowing in the casing through the shaft; a rotor disposed in the casing to form a space for filtering the fluid injected from the stand tube by rotating with the stand tube, and having nozzles injecting the filtered fluid into the casing; and a filtering unit elongated in a longitudinal direction of the shaft, disposed in the rotor to divide an inside of the rotor into an upper space and a lower space, and having a plurality of fluid holes for guiding the fluid injected in the upper space from the stand tube into the lower space.

In the hybrid centrifugal filter, the filtering unit may include: an outer cylinder inserted in the rotor, with an inner side thereof in contact with an outer side of the rotor; an inner cylinder combined with the stand tube, with an inner side thereof in contact with an outer side of the stand tube; and a cell assembly connecting the outer cylinder and the inner cylinder to each other and elongated in a longitudinal direction of the filtering unit.

In the hybrid centrifugal filter, the filtering unit may be formed such that the top and the bottom are recessed toward the center close to the shaft.

In the hybrid centrifugal filter, the filtering unit may be inserted between the rotor and the stand tube and may rotate with the rotor.

According to the present invention, the surface area that comes in contact with fluid and impurities is increased by the fluid holes formed in the filtering unit disposed in the rotor, as compared with the centrifugal filters of the related art, so efficiency of removing impurities can be improved.

Further, since the fluid holes are uniformly distributed throughout the filtering unit, it is possible to remove even fine impurities that are less influenced by centrifugal force.

Further, there is no need for a separator for dividing the inside of the rotor to discharge only filtered fluid, so it is possible to simplify the other structure of the centrifugal filter except the filtering unit.

### DESCRIPTION OF DRAWINGS

FIG. 1 is a cross-sectional view showing the configuration of a centrifugal filter of the related art.

FIG. 2 is a cross-sectional view showing the structure of a hybrid centrifugal filter according to an embodiment of the present invention.

FIG. 3 is a plan view showing an exemplary structure of a filtering unit according to the present invention.

FIG. 4 is a plan view showing another exemplary structure of a filtering unit according to the present invention.

FIG. 5 is a plan view showing the structure of a cell assembly according to the present invention.

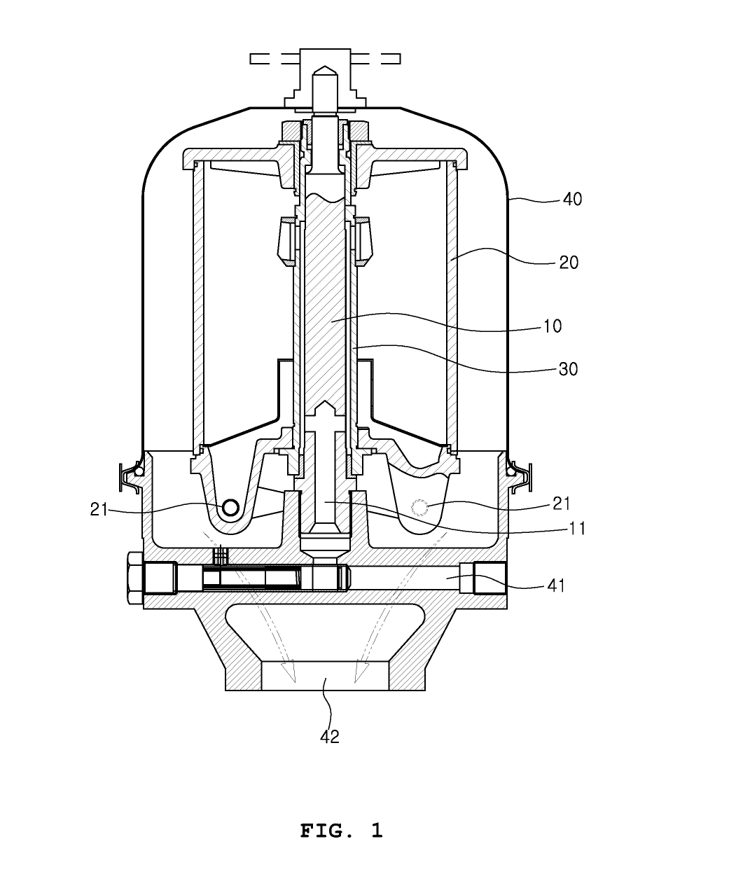

<Description of the Reference Numerals in the Drawings>

| | |
|---|---|
| 110: Casing | 111: Fluid inlet |
| 112: Fluid outlet | 120: Shaft |
| 130: Stand tube | 140: Rotor |
| 141: Nozzle | 150: Filtering unit |
| 151: Outer cylinder | 152: Inner cylinder |
| 153: Cell assembly | 154: Fluid hole |

### MODE FOR INVENTION

Hereinafter, exemplary embodiments of the present invention are described in detail with reference to the accompanying drawings. However, in describing the present invention, detailed descriptions of well-known functions or configurations will be omitted so as not to obscure the description of the present invention with unnecessary detail

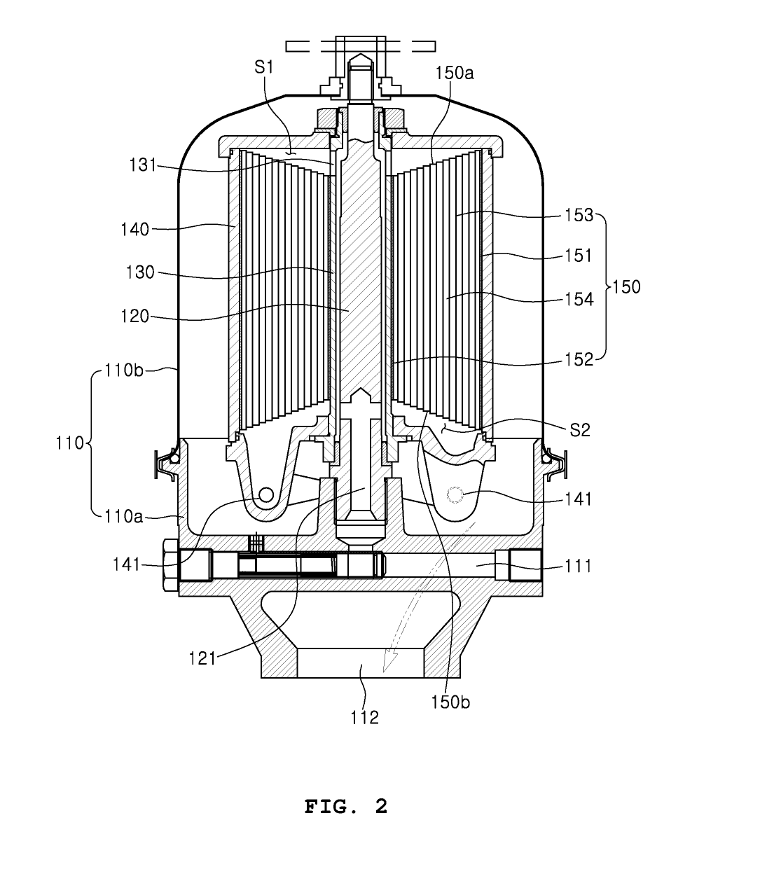

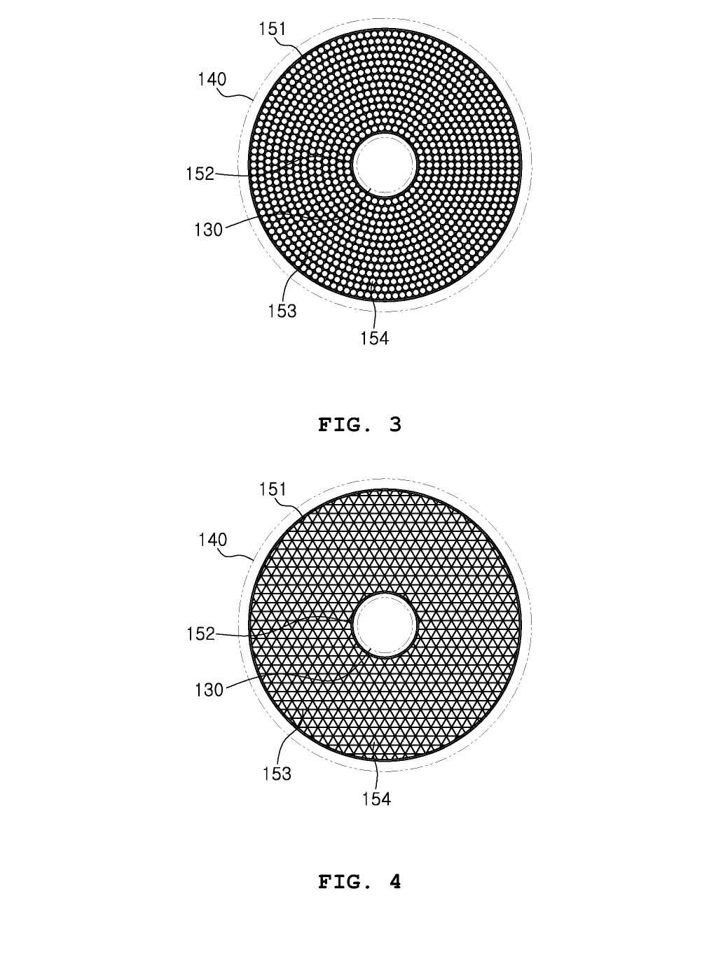

FIG. 2 is a cross-sectional view showing the structure of a hybrid centrifugal filter according to an embodiment of the present invention, FIG. 3 is a plan view showing an exemplary structure of a filtering unit according to the present invention, and FIG. 4 is a plan view showing another exemplary structure of a filtering unit according to the present invention.

A hybrid centrifugal filter according to the present invention includes a casing 110, a shaft 120, a stand tube 130, a rotor 140, and a filtering unit 150.

The casing 110, which accommodates the shaft 120, the stand tube 130, and the rotor 140 while forming the outer structure of the centrifugal filter, is composed of a base 110a having a fluid inlet 111 and a fluid outlet 112 and a cover 110b having a cylindrical shape with an open bottom and coupled to the upper end of the base 110a.

The shaft 120 is vertically disposed in the case 110 to support rotation of the stand tube 130 and the rotor 140 and has a channel 121 therein to guide fluid, which flows inside through the fluid inlet 111, into the casing 110.

The stand tube 130 rotates with the rotor 140 about the shaft 120 and has a plurality of holes 131 at the upper end to inject fluid, which flows inside through shaft 120, into the rotor 140.

The holes 131 of the stand tube 130 are formed at the upper end of the stand tube 130 so that fluid can be injected into the rotor 140 at as high of a position as possible.

The rotor 140 is disposed in the casing 110 to form a space for filtering fluid injected from the stand tube 130 while rotating with the stand tube 130, and has one or more nozzles 141 at the lower end to inject the filtered fluid into the casing 110.

Centrifugal filters of the related art remove impurities using a paper attached on the inner side of a rotor, but the hybrid centrifugal filter according to the present invention is different in that a specific filtering unit 150 is provided in the rotor 140 instead of the paper.

The filtering unit 150 has a structure elongated in the longitudinal direction of the shaft 120 in the rotor 140, divides the inside of the rotor 140 into an upper space S1 and a lower space S2, and has a plurality of fluid holes 154 that form channels for fluid injected into the upper space S1 from the stand tube 130 to flow outside through the lower space S2.

The filtering unit 150, which is a disposable part that needs to be replaced with a new one after a predetermined of period, is inserted between the rotor 140 and the stand tube 130, that is, the filtering unit 150 may be inserted between the rotor 140 and the stand tube 130 to rotate with the rotor 140 and be coupled to the rotor 140 and the stand tube 130 by appropriate pressure from the rotor 140 and the stand tube 130.

The filtering unit 150 may be composed of an outer cylinder 151, an inner cylinder 152, and a cell assembly 153.

The outer cylinder 151, which forms the outer structure of the filtering unit 150, has entirely a cylindrical shape, has an outer diameter corresponding to the inner diameter of the rotor 140 such that the outer side of the outer cylinder 151 is in contact with the inner side of the rotor 140, and has a height corresponding to the height of the rotor 140 to fully cover the inner side of the rotor 140 in contact with the inner side of the rotor 140.

The inner cylinder 152 forms the central structure of the filtering unit 150 such that the filtering unit 150 can be fitted on the stand tube 130, has entirely a cylindrical shape, and is disposed at the center of the outer cylinder 151 coaxially with the outer cylinder 151. The inner cylinder 152 has an inner diameter corresponding to the outer diameter of the stand tube 130 such that the inner side is in contact with the outer side of the stand tube 130.

The cell assembly 153 connects the outer cylinder 151 and the inner cylinder 152 to each other and has a plurality of fluid holes 154 elongating in the longitudinal direction of the filtering unit 150, between the outer cylinder 151 and the inner cylinder 152.

The cross-section of the fluid holes 154 of the cell assembly 153 is not specifically limited and may be formed in various shapes. For example, as shown in FIG. 3, the fluid holes 154 may have a circular cross-section, or as shown in FIG. 4, they may have a triangular cross-section. Further, polygonal cross-sections such as a rectangle, a pentagon, or a hexagon may be possible.

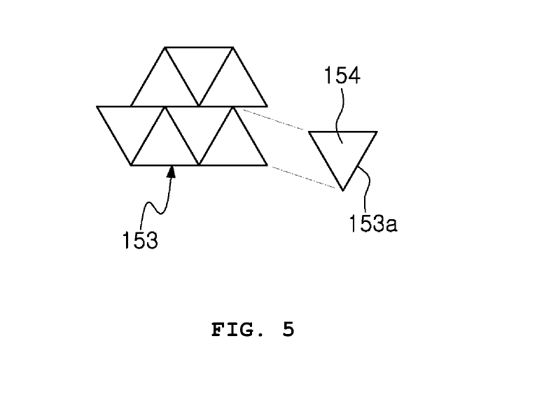

The cell assembly 153 may be formed by combining a plurality of cell units 153a each having a fluid hole 154 having a circular or a polygonal cross-section (see FIG. 5), or may be formed by connecting the outer cylinder 151 and the inner cylinder 152 using a plurality of walls such that the walls form circular or polygonal fluid holes 154 by crossing each other.

According to the cell assembly, the surface area that comes in contact with fluid or impurities is increased several times to tens of times, as compared with the centrifugal filters of the related art, by the fluid holes 154 formed between the outer cylinder 151 and the inner cylinder 152. For reference, fluid and impurities injected into the upper space S1 of the rotor 140 stick to the inner sides of the fluid holes 154 while flowing through the fluid holes 154, so the inner sides of the fluid holes 154 function as surfaces that remove impurities. Accordingly, the surface area for removing impurities can be remarkably increased in comparison to the centrifugal filters of the related art.

Further, the fluid holes 154 are distributed throughout the space between the rotor 140 and the stand tube 130, so it is possible to remove even 10 μm or less particles that are relatively less influenced by centrifugal force.

The filtering unit 150 has a structure in which the top 150a and the bottom 150b are recessed toward the center close to the shaft 120. In other words, the top 150a of the filtering unit 150 is recessed down toward the center, so a space that allows fluid and impurities injected from the stand tube 130 to sufficiently spread to the upper space S1 is formed. Further, the bottom 150b of the filtering unit 150 is recessed up toward the center, so a space that allows fluid discharged to the lower space S2 through the fluid holes 154 to smoothly flow to the nozzles at the lower rend of the rotor 140 is formed.

The filtering unit 150 divides the inside of the rotor 140 into the upper space S1 and the lower space S2 and has the fluid holes 154 connecting the upper space S1 and the lower space S2, and various materials, not specific materials, can be used to satisfy this structure.

The hybrid centrifugal filter according to the present invention having this configuration can be used to filter impurities in some of lubricant that is circulated in an engine or mechanical devices by a pump, similar to the centrifugal filters of the related art, and a detailed filtering process is as follows.

Fluid sent into the casing 110 through the fluid inlet 111 by a pump flows into the stand tube 130 through the shaft 120 and is then injected into the upper space S1 in the rotor 140 through the holes 131 of the stand tube 130.

The fluid injected in the upper space S1 flows into the lower space S2 through the fluid holes 154 of the filtering unit 150, and in this process, impurities flowing with the fluid or separated from the fluid by centrifugal force stick to the inner sides of the fluid holes 154 and remain in the filtering unit 150, while the fluid is discharged into the lower space S2 through the fluid holes 154 and then injected into the casing 110 through the nozzles 141.

On the other hand, impurities having a particle size of 10 μm or less cannot reach the inner side of the rotor 140 because they are relatively less influenced by centrifugal force and drop around the stand tube 130, so the centrifugal filters of the related art could not effectively filter impurities having a particle size of 10 μm or less. However, according to the centrifugal filter of the present invention, even the fine impurities that cannot reach the inner side of the rotor 140 and drop at positions close to the stand tube 130 stick to the inner sides of the fluid holes 154 while flowing with fluid through the fluid holes 154 of the filtering unit 150. Accordingly, it is possible to remove even fine impurities having a particle size of 10 μm or less that the centrifugal filters of the related art could not filter.

Further, the sum of the areas of the inner sides of the fluid holes 154 is several times or tens of times larger than the area of the inner sides of rotors in centrifugal filters of the related art, so the surface area that impurities come in contact with is increased and accordingly, the efficiency of removing impurities can be considerably increased.

The present invention is not limited to the embodiments described above and may be changed and modified in various way by those skilled in the art without departing from the scope of the present invention, and the modifications are included in claims.

What is claimed is:

1. A hybrid centrifugal filter comprising:
a casing (110) having a fluid inlet (111) and a fluid outlet (112);
a shaft (120) vertically disposed in the casing (110) and guiding fluid, which flows inside through the fluid inlet (111), into the casing (110);
a stand tube (130) being rotatable about the shaft (120) and injecting fluid flowing in the casing (110) through the shaft (120);
a rotor (140) disposed in the casing (110) to form a space for filtering the fluid injected from the stand tube (130) by rotating with the stand tube (130), and having nozzles (141) injecting the filtered fluid into the casing (110); and
a filtering unit (150) elongated in a longitudinal direction of the shaft (120), disposed in the rotor (140) to divide an inside of the rotor (140) into an upper space (S1) and a lower space (S2), and having a plurality of fluid holes (154) for guiding the fluid injected in the upper space (S1) from the stand tube (130) into the lower space (S2).

2. The hybrid centrifugal filter of claim 1, wherein the filtering unit (150) includes:
an outer cylinder (151) inserted in the rotor (140), with an inner side thereof in contact with an outer side of the rotor (140);
an inner cylinder (152) combined with the stand tube (130), with an inner side thereof in contact with an outer side of the stand tube (130); and
a cell assembly (153) connecting the outer cylinder (151) and the inner cylinder (152) to each other and elongated in a longitudinal direction of the filtering unit (150).

3. The hybrid centrifugal filter of claim 1, wherein the filtering unit (150) is inserted between the rotor (140) and the stand tube (130) and rotates with the rotor (140).
